(19) United States
(12) Patent Application Publication
(10) Pub. No.: US 2025/0036390 A1
(43) Pub. Date: Jan. 30, 2025

(54) DEVICE AND METHOD FOR AUTOMATICALLY BURNING FIRMWARE

(71) Applicant: Fulian Precision Electronics (Tianjin) Co., LTD., Tianjin (CN)

(72) Inventors: Teng-Fei Ma, Tianjin (CN); Jie Yuan, Tianjin (CN)

(21) Appl. No.: 18/602,178

(22) Filed: Mar. 12, 2024

(30) Foreign Application Priority Data
Jul. 28, 2023 (CN) 202310948865.X

(51) Int. Cl. G06F 8/65

(52) U.S. Cl. CPC G06F 8/65

(57) ABSTRACT

A device and a method for automatically burning firmware are provided. The device includes a first communication unit, a second communication unit, and a processing unit. The processing unit is connected with the first communication unit and the second communication unit. The first communication unit establishes a communication connection with the first electronic device and receives a to-be-burned firmware from the first electronic device. The second communication unit establishes a wired communication with a PCIe Switch. The processing unit obtains the to-be-burned firmware received by the first communication unit and burns the to-be-burned firmware to the PCIe Switch through the second communication unit.

### CROSS-REFERENCE TO RELATED APPLICATIONS

This application claims priority to Chinese Patent Application No. 202310948865.X filed on Jul. 28, 2023, in China National Intellectual Property Administration, the contents of which are incorporated by reference herein.

### FIELD

The subject matter herein generally relates to firmware burning technologies, and specially relates to a device and a method for automatically burning firmware.

### BACKGROUND

A normal operation of a peripheral component interface express switch (PCIe Switch) requires a firmware to support. However, an out-of-band upgrade to the firmware of the PCIe Switch requires an operator to connect a personal computer (PC) to a debug port of the PCIe Switch through a serial cable, and input commands to the PC for burning a firmware prestored in the PC to the PCIe Switch. The above described method is difficult to be applied to a production line, has time consuming to install, and may indirectly affect a work progress.

Therefore, there is room for improvement within the art.

### BRIEF DESCRIPTION OF THE DRAWINGS

Implementations of the present disclosure will now be described, by way of example only, with reference to the attached figures.

FIG. 1 is a schematic diagram illustrating a firmware burning system according to an embodiment of the present disclosure.

FIG. 2 is a schematic diagram illustrating a firmware burning device according to an embodiment of the present disclosure.

FIG. 3 is a schematic diagram illustrating a firmware burning device according to another embodiment of the present disclosure.

FIG. 4 is a flow chart illustrating a method for automatically burning firmware according to an embodiment of the present disclosure.

FIG. 5 is a flow chart illustrating a method for automatically burning firmware according to another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “comprising,” when utilized, means “including, but not necessarily limited to”; it specifically indicates open-ended inclusion or membership in the so-described combination, group, series, and the like.

A peripheral component interface express switch (PCIe Switch) is a module for expanding a PCIe port. The PCIe port is a high-speed serial computer extension bus standard interface.

Generally, the PCIe Switch includes an upstream port and a plurality of downstream ports. The upstream port is used to connect to a Central Processing Unit (CPU) or a Root Complex (RC). Each downstream port is used to connect to a PCIe Endpoint. The PCIe Endpoint can be, but is not limited to, a CPU, a Graphics Processing Unit (GPU), a Solid State Disk (SSD), and a network card. In some embodiments, the upstream port of the PCIe Switch can also connect to the downstream ports of other PCIe Switches, and the downstream ports of the PCIe Switch can also connect to the upstream ports of other PCIe Switches, thereby expanding more PCIe ports.

The PCIe Switch is used to forward a data received by the upstream port to corresponding downstream ports, thereby, providing routing and forwarding services for devices connected to the PCIe Switch.

A normal operation of the PCIe Switch requires a firmware to support. The firmware is an underlying code of an electronic device for connecting a hardware and an operating system. The firmware is typically stored in a memory of the electronic device, such as an Electrically Erasable Programmable read only memory (EEPROM) or a Flash Memory.

When the PCIe Switch fails or the firmware of the PCIe Switch needs to be upgraded, updated, or replaced, a new firmware needs to be burned to the PCIe Switch. Upgrading firmware, updating firmware, or replacing firmware means modifying or replacing the underlying code to make the hardware of the electronic device to add new functions or to work better.

Currently, if the PCIe Switch fails and the firmware of the PCIe Switch cannot be updated by an in-band upgrade mode, an emergency rescue is performed. The emergency rescue means re-burning the firmware through an out-of-band upgrade. However, the out-of-band upgrade method is difficult to be applied to a production line, has a high time cost of installation, and will indirectly affect a work progress.

Therefore, a device and a method for automatically burning firmware are provided. The device and method are easy to be applied to the production line, have a less time cost of installation, and will increase work efficiency.

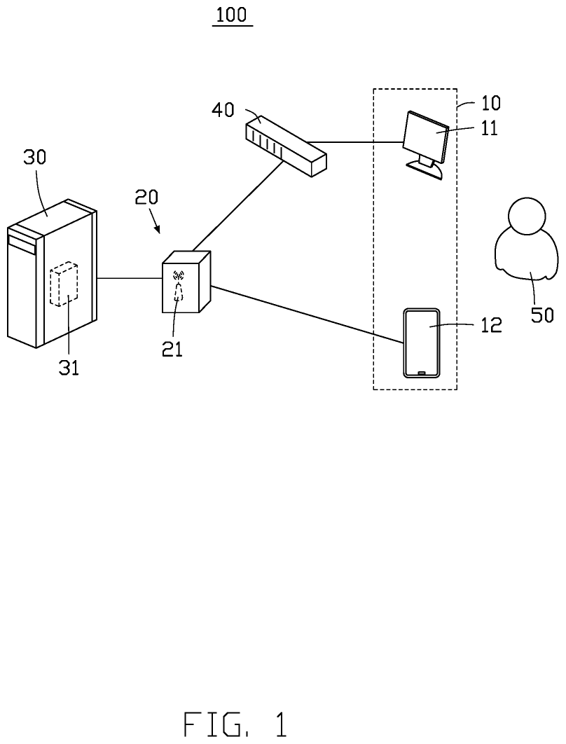

FIG. 1 illustrates a structure of a firmware burning system 100. The firmware burning system 100 includes a first electronic device 10, a firmware burning device 20, and a second electronic device 30. The second electronic device 30 includes a PCIe Switch 31.

In this embodiment, the first electronic device 10 stores a to-be-burned firmware.

In this embodiment, the firmware burning device 20 includes a refresh script, a first test script, and a second test script. The refresh script is a program for burning the to-be-burned firmware to the PCIe Switch 31. The first test script is a program for testing whether the firmware is successfully burned. The second test script is a program for testing whether a firmware successfully burned supports a normal operation of the PCIe Switch 31.

In this embodiment, when the refresh script is runed, the firmware burning device 20 can burn the to-be-burned firmware to the PCIe Switch 31 of the second electronic device 30. When the first test script is runed, the firmware burning device 20 can obtain a first firmware information of a current firmware from the PCIe Switch 31 and determine whether the to-be-burned firmware is successfully burned to the PCIe Switch 31 based on the first firmware information and a preset firmware information.

In this embodiment, a firmware information includes, but is not limited to, a firmware version number and a timestamp. The timestamp may be a timestamp when burning the firmware. The timestamp may also be a timestamp when a compilation of the firmware is finished.

In this embodiment, the current firmware is the firmware of the PCIe Switch 31. For example, when a to-be-burned firmware A is successfully burned to the PCIe Switch 31, the firmware A is the firmware stored in the PCIe Switch 31, that is, the firmware A is the current firmware of the PCIe Switch 31.

In this embodiment, the first firmware information includes a first firmware version number of the current firmware of the PCIe Switch 31 and/or a first timestamp. The predetermined firmware information includes a second firmware version number of the to-be-burned firmware and/or a second timestamp.

The first timestamp and the second timestamp can be the timestamp when the firmware is burned, or the timestamp when a compilation of the firmware is finished. Following, for a convenience of description, taking the first timestamp being the timestamp when the current firmware is burned to the PCIe Switch 31, and the second timestamp being the timestamp when the to-be-burned firmware is burned to the PCIe Switch 31 as examples.

It should be noted that the first firmware information is an information about the current firmware of the PCIe Switch 31, which can be stored to the PCIe Switch 31. The predetermined firmware information is an information about the firmware burning device 20 burning the to-be-burned firmware to the PCIe Switch 31, which can be stored to the firmware burning device 20. That is, the firmware burning device 20 can obtain a second firmware version number of the to-be-burned firmware and the time for burning the to-be-burned firmware to the PCIe Switch 31.

In this embodiment, when the second test script is runed, the firmware burning device 20 can obtain a first operation information of the PCIe Switch 31 and determine whether the firmware successfully burned supports a normal operation of the PCIe Switch 31 based on the first operation information.

It should be noted that an output status by the PCIe Switch 31 is different when it is normal operation and when it is abnormal operation.

The first operation information of the PCIe Switch 31 is a running information of the PCIe Switch 31 supported by the firmware being successfully burned. The first operation information includes, but is not limited to, a run log record of the PCIe Switch 31 supported by the firmware being successfully burned and relevant register data of the PCIe Switch 31 supported by the firmware being successfully burned.

In this embodiment, a communication connection is established between the first electronic device 10 and the firmware burning device 20. The first electronic device 10 and the firmware burning device 20 may realize a transmission of information through the established communication connection. The information transmitted between the first electronic device 10 and the firmware burning device 20 includes, but is not limited to, the to-be-burned firmware, instructions, an information related to burning, and an information related to an operation of the PCIe Switch 31. The information related to burning can be, for example, an information of successful burning, an information of burning failure. The information related to an operation of the PCIe Switch 31 can be, for example, the firmware supporting the normal operation of the PCIe Switch 31, the firmware cannot support the normal operation of the PCIe Switch 31, and the first operation information of the PCIe Switch 31.

In this embodiment, the first electronic device 10 and the firmware burning device 20 establish a wireless communication. Exemplarily, the first electronic device 10 and the firmware burning device 20 may establish a wireless communication through, global system for mobile communications (GSM), general packet radio service (GPRS), code division multiple access (CDMA), wideband code division multiple access (WCDMA), Long Term Evolution (LTE), Bluetooth (BT), wireless fidelity (Wi-Fi), Near Field Communication (NFC), voice over Internet protocol (VOIP), and other communication protocols, which is not limited in this embodiment.

In some embodiments, the first electronic device 10 and the firmware burning device 20 may establish a wired communication. Exemplarily, the first electronic device 10 and the firmware burning device 20 may establish a wired communication through a serial cable or a Universal Serial Bus (USB).

In this embodiment, the first electronic device 10 may be a cell phone, a laptop computer, a tablet, an Ultra-mobile Personal Computer (UMPC), a handheld computer, a netbook, a Personal Digital Assistant (PDA), and other electronic devices, which is not limited in this embodiment.

In this embodiment, the firmware burning device 20 may be a device with an operating system, for example, a microcontroller, a chip, a minicomputer, or a computer. The operating system may be, but is not limited to, a GNU operating system and a Linux operating system. Exemplarily, the firmware burning device 20 may be a Raspberry Pi. The Raspberry Pi is a microcomputer based on an Advanced RISC Machine (ARM) processor.

As shown in FIG. 1, in a first situation, a wireless communication between the first electronic device 10 and the firmware burning device 20 is described by taking the first electronic device 10 as a laptop computer 11. The laptop computer 11 and the firmware burning device 20 can establish a local area network (LAN) through a network switch 40 and an Access Point (AP) (not shown). The firmware burning device 20 and the laptop computer 11 realize the wireless communication though the LAN.

In this embodiment, based on the wireless communication, the laptop computer 11 can transmit a prestored to-be-burned firmware and/or the instructions to the firmware burning device 20. For example, the laptop computer 11 can transmit the to-be-burned firmware and/or the instructions to the firmware burning device 20 through a File Transfer Protocol (FTP).

In some embodiments, other laptop computers can also join the LAN through the network switch 40 to form an Internet of Things (IoT). Then, other laptop computers can also control the firmware burning device 20.

In some embodiments, the network switch 40 may be a wired network switch, which is not limited.

In a second situation, the laptop computer 11 can transmit the to-be-burned firmware to the cell phone 12 through Bluetooth transmission technology. The cell phone 12 obtains the to-be-burned firmware and transmits the to-be-burned firmware to the firmware burning device 20. For example, as shown in FIG. 1, the wireless communication between the first electronic device 10 and the firmware burning device 20 is described by taking the first electronic device 10 as a cell phone 12.

The firmware burning device 20 includes an antenna 21. The firmware burning device 20 establishes a Bluetooth communication or a Wi-Fi communication with the cell phone 12 through the antenna 21. Based on the Bluetooth communication, the cell phone 12 can transmit the pre-stored and to-be-burned firmware to the firmware burning device 20 through a Bluetooth transmission technology.

The firmware burning device 20 can establish a communication with the PCIe Switch 31 to realize an information transmission. The information transmitted between the PCIe Switch 31 and the firmware burning device 20 includes, but is not limited to, the to-be-burned firmware, the instructions, the information related to the operation of the PCIe Switch 31, and the firmware information. The firmware information can be the first firmware information and the preset firmware information. The information related to the operation of the PCIe Switch 31, the first firmware information and the preset firmware information can refer to the above and do not describe here.

In this embodiment, the firmware burning device 20 may be connected to the PCIe Switch 31 of the second electronic device 30 through an external bus. Exemplarily, the firmware burning device 20 includes a Universal Asynchronous Receiver-Transmitter (UART) port. The UART port of the firmware burning device 20 connects to the debug port of the PCIe Switch 31 through the external bus. In this embodiment, the external bus can be, but is not limited to, a serial cable. The debug port is also known as a serial debug (SDB) port and is the UART port.

In this embodiment, the second electronic device 30 may be a server or other electronic devices including a memory system. The electronic device including the memory system may be, but is not limited to, an IoT device, a mobile communication device, an automobile.

In this embodiment, the PCIe Switch 31 may be a physical device, such as a physical switch or a switch chip. The PCIe Switch 31 may also be a hardware function module implemented on a chip. For example, the PCIe Switch 31 may be a hardware function module integrated in a processor chip to implement the PCIe Switch functions.

In this embodiment, the firmware burning device 20 may be deployed together with the second electronic device 30 and establishes the wireless communication with the first electronic device 10. Then, the first electronic device 10 can remotely control the firmware burning device 20 to burn the firmware to the PCIe Switch 31, which needn't an operator 50 to arrive at the deployment site of the second electronic device 30.

The following will provide an exemplary introduction of a working process of the firmware burning system 100.

Step 1, The to-be-burned firmware may be stored to the first electronic device 10. In some embodiments, the to-be-burned firmware from a PCIe Switch vendor can be obtained and be stored to the first electronic device 10.

Step 2, a first instruction is inputted to the first electronic device 10. The first instruction indicates establishing the wireless communication between the firmware burning device 20 and the first electronic device 10.

Step 3, a second instruction is inputted to the first electronic device 10. The second instruction indicates transmitting the to-be-burned firmware stored in the first electronic device 10 to the firmware burning device 20.

Step 4, a third instruction is inputted to the first electronic device 10. Then, the first electronic device 10 receives and transmits the third instruction to the firmware burning device 20. The third instruction indicates the firmware burning device 20 to burn the to-be-burned firmware to the PCIe Switch 31.

Step 5, the firmware burning device 20 runs the refresh script according to the third instruction and burns the to-be-burned firmware to the PCIe Switch 31. Then, the firmware burning device 20 restarts the PCIe Switch 31 after burning the to-be-burned firmware to the PCIe Switch 31.

Step 6, a fourth instruction is inputted to the first electronic device 10. Then, the first electronic device 10 receives and transmits the fourth instruction to the firmware burning device 20. The fourth instruction indicates the firmware burning device 20 to detect whether the to-be-burned firmware is successfully burned.

Step 7, after the to-be-burned firmware is burned to the PCIe Switch 31, the firmware burning device 20 runs the first test script according to the fourth instruction, obtains the first firmware information of the current firmware sent by the PCIe Switch 31, and determines whether the to-be-burned firmware is successfully burned based on the first firmware information and the predetermined firmware information.

Step 8, when the firmware burning device 20 detects that the first firmware information is consistent with the predetermined firmware information, the firmware burning device 20 determines the to-be-burned firmware is burned to the PCIe Switch 31 successfully and sends the information of successful burning to the first electronic device 10. So that, the operator 50 can know the to-be-burned firmware is successfully burned.

Step 9, when the firmware burning device 20 detects that the first firmware information is inconsistent with the predetermined firmware information, the firmware burning device 20 determines the to-be-burned firmware is not burned to the PCIe Switch 31 and sends the information of burning failure to the first electronic device 10. So that, the operator 50 can know the to-be-burned firmware is not successfully burned.

Step 10, after the operator 50 knows that the firmware has been successfully burned, the operator 50 inputs a fifth instruction to the first electronic device 10. Then the first electronic device 10 transmits the fifth instruction to the firmware burning device 20. The fifth instruction indicates the firmware burning device 20 to detect whether the successfully burned firmware supports the normal operation of the PCIe Switch 31.

Step 11, after the firmware burning device 20 determines that the to-be-burned firmware is successfully burned to the PCIe Switch 31, the firmware burning device 20 runs the second test script according to the fifth instruction, obtains the first operation information of the PCIe Switch 31 with the support of the firmware that has been successfully burned, and determines whether the firmware successfully burned supports the normal operation of the PCIe Switch 31 according to the first operation information.

Step 12, when the firmware burning device 20 determines that the firmware successfully burned supports the normal operation of the PCIe Switch 31 according to the first operation information, the firmware burning device 20 sends an information to the first electronic device 10 to indicate the PCIe Switch 31 operates normally, thereby the operator 50 can know the firmware successfully burned can support the normal operation of the PCIe Switch 31.

Step 13, when the firmware burning device 20 determines that the firmware successfully burned does not support the normal operation of the PCIe Switch 31 according to the first operation information, the firmware burning device 20 sends an information to the first electronic device 10 to indicate an operation of the PCIe Switch 31 being abnormal, thereby the operator 50 can know the successfully burned firmware does not support the normal operation of the PCIe Switch 31.

In some embodiments, the above instructions do not necessarily come from operator 50.

Specific conditions for generating specific instructions may be set in advance, and when the firmware burning device 20 runs to the specific conditions, the corresponding specific instructions are automatically executed. For example, when the firmware burning device 20 automatically runs the refresh script after obtaining the to-be-burned firmware, the operator 50 is not required to enter the third instruction. For another example, after the firmware burning device 20 burns the to-be-burned firmware to the PCIe Switch 31, the firmware burning device 20 automatically restarts the PCIe Switch 31 and automatically runs the first test script after restarting the PCIe Switch 31, and inputting the fourth instruction by the operator 50 is not needed. As another example, after the firmware burning device 20 runs the first test script to determine that the firmware was successfully burned, the firmware burning device 20 automatically runs the second test script and inputting the fifth instruction by the operator 50 is not needed.

In this embodiment, the way of the first electronic device 10 obtaining an input instruction from the operator 50 may include, the first electronic device 10 receiving an operation of the operator 50 through a manual interaction function. The manual interaction function includes, but is not limited to, the operator 50 presses a corresponding button, triggers a corresponding control, or inputs a corresponding voice. Exemplarily, if the operator 50 trigger a connection control, then the first electronic device 10 receives the first instruction to establish the communication between the first electronic device 10 and the firmware burning device 20. When the operator 50 triggers a refresh control, the first electronic device 10 receives the third instruction to control the firmware burning device 20 to execute the refresh script for burning the to-be-burned firmware to the PCIe Switch 31. Thus, the operator 50 only needs to perform a simple command delivery operation. Then the firmware burning device 20 can be remotely controlled through the first electronic device 10, to burn the to-be-burned firmware to the PCIe Switch 31 of the second electronic device 30 and automatically perform the relevant detection without inputting instructions, which can effectively reduce a technical ability of operator 50.

It should be noted that numbers and types of the first electronic device 10, the second electronic device 30, and the firmware burning device 20 of the firmware burning system 100 shown in FIG. 1 are only examples, and each may be an integer greater than or equal to one.

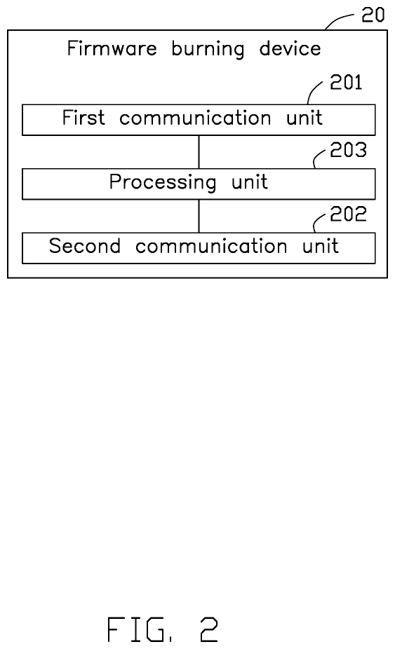

FIG. 2 illustrates a structure of the firmware burning device 20.

The firmware burning device 20 includes a first communication unit 201, a second communication unit 202, and a processing unit 203.

In this embodiment, the first communication unit 201 is used to establish the communication connection between the firmware burning device 20 and the first electronic device 10, so as to realize the transmission of information between the firmware burning device 20 and the first electronic device 10. The contents of establishing the communication connection between the firmware burning device 20 and the first electronic device 10 and the contents of the information transmitted between the firmware burning device 20 and the first electronic device 10 can be referred to above and will not be repeated here.

In some embodiments, the first communication unit 201 can include a wireless communication module (not shown) to realize the wireless communication between the firmware burning device 20 and the first electronic device 10. For example, the first communication unit 201 includes, but is not limited to, a Wi-Fi communication module, a network switch module, a Bluetooth communication module, a Zigbee module.

In other embodiments, the first communication unit 201 can also include a wired communication module (not shown) to realize a wired communication between the firmware burning device 20 and the first electronic device 10. For example, the first communication unit 201 include, but is not limited to, a UART module and a USB communication module.

In this embodiment, the second communication unit 202 is used to establish the communication connection between the firmware burning device 20 and the PCIe Switch 31. The second communication unit 202 may also include a wired communication module as described above and will not be repeated here. Exemplarily, taking the second communication unit 202 including a UART module as an example. The UART module includes a UART port. The UART port of the PCIe Switch 31 is connected to the UART port of the firmware burning device 20 through an external bus. Thus, the firmware burning device 20 can transmit information to the PCIe Switch 31 through the UART port. For example, the firmware burning device 20 can burn the to-be-burned firmware to the PCIe Switch 31 through the UART port.

The processing unit 203 is used to perform the method for automatically burning firmware in this embodiment, for example, obtaining the to-be-burned firmware received by the first communication unit 201 and burning the to-be-burned firmware to the PCIe Switch 31 through the second communication unit 202.

The processing unit 203 may be a CPU, a general purpose processor, a programmable logic device, a discrete gate, a transistor logic device, a discrete hardware component, and the like. The processing unit 203 runs the operating system, such as a Linux operating system. The programmable logic device can be, but is not limited to, a Digital Signal Processor (DSP) and an Application Specific Integrated Circuit (ASIC).

In some embodiments, the processing unit 203 is also used to store the information transmitted between the firmware burning device 20 and the first electronic device 10, and the information transmitted between the firmware burning device 20 and the PCIe Switch 31.

In some embodiments, the processing unit 203 includes a cache for storing the information, the refresh script, the first detection script, and the second detection script.

In this embodiment, through the first communication unit 201, the wireless communication between the firmware burning device 20 and the first electronic device 10 is realized. Through the second communication unit 202, the wired communication connection between the firmware burning device 20 and the PCIe Switch 31 is realized. Therefore, the operator 50 can remotely control the firmware burning device 20 through the first electronic device 10 to realize remote automatic firmware burning.

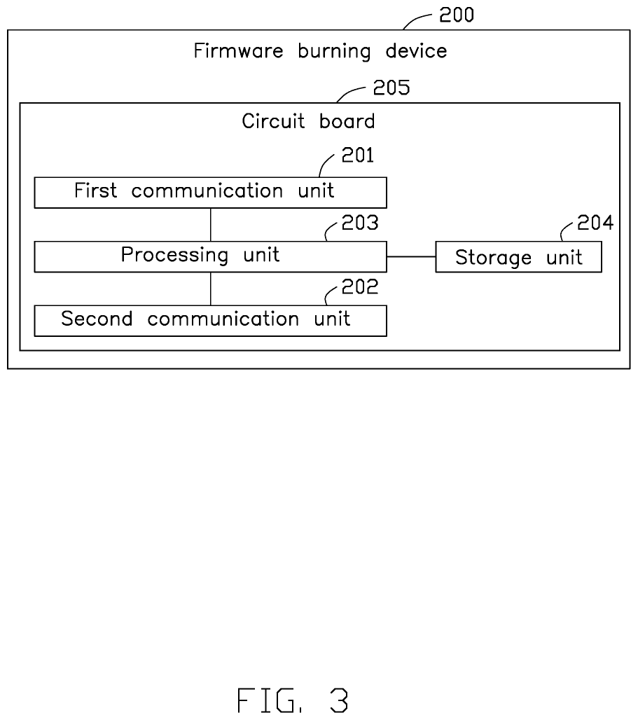

FIG. 3 illustrates another structure of the firmware burning device 200.

As shown in FIG. 3, the firmware burning device 200 includes the first communication unit 201, the second communication unit 202, and the processing unit 203. Descriptions of the first communication unit 201, the second communication unit 202, and the processing unit 203 can be referred to the above and will not be repeated here.

In this embodiment, the firmware burning device 200 differs from the firmware burning device 20 shown in FIG. 2 in that the firmware burning device 200 further includes a storage unit 204 and a circuit board 205.

In this embodiment, the storage unit 204 is used to store the operating system, such as the GNU/Linux operating system.

In some embodiments, the refresh script, the first test script, the second test script, Linux tools related to the PCIe Switch 31, the information transmitted between the firmware burning device 200 and the first electronic device 10 and the information transmitted between the firmware burning device 200 and the PCIe Switch 31 can be stored to the storage unit 204.

In some embodiments, when the firmware burning device 200 runs the refresh script, burning the firmware to the PCIe Switch 31 can be realized with a help of the software tools provided by the vendor of the PCIe Switch 31. When the firmware burning device 200 runs the first test script, the software tools provided by the vendor of the PCIe Switch 31 can be used to obtain the first firmware information from the PCIe Switch 31. When the firmware burning device 200 runs the second test script, the software tools provided by the vendor of the PCIe Switch 31 can be used to obtain the first operational information from the PCIe Switch 31.

The storage unit 204 may be an external memory and/or an internal memory.

The circuit board 205 is used to support one or more of the first communication unit 201, the second communication unit 202, the processing unit 203, and the storage unit 204. When the firmware burning device 20 is implemented as a Raspberry Pi, the circuit board 205 may be a Raspberry Pi development board or another development board based on a Linux operating system.

As shown in FIG. 3, due to the firmware burning device 200 includes the circuit board 205, which can integrate the hardware, thereby reducing a size of the required hardware and allowing the firmware burning device 200 to be easily deployed to the site of the second electronic device 30.

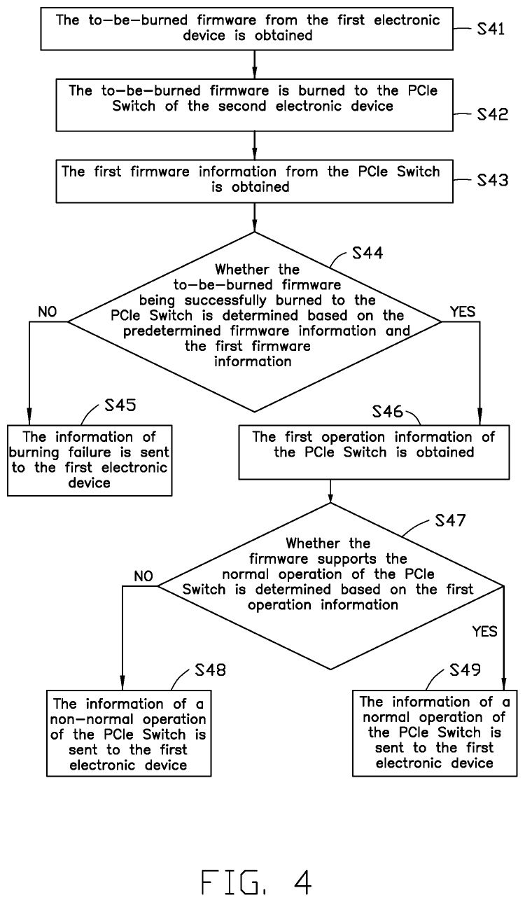

FIG. 4 illustrates a method for automatically burning firmware. The method may be applied to the firmware burning system 100 shown in FIG. 1. The method may be performed by the firmware burning devices 20, 200, or by the processing unit 203 of the firmware burning devices 20, 200. Following, for a convenience of description, taking the method being performed by the firmware burning device 200 as an example. Then, as shown in FIG. 4, the method includes the following steps:

At block S41, the to-be-burned firmware from the first electronic device 10 is obtained.

In this embodiment, the firmware burning device 200 obtains the to-be-burned firmware from the first electronic device 10 based on the communication connection with the first electronic device 10. After obtaining the to-be-burned firmware, the firmware burning device 200 stores the to-be-burned firmware, for example, stores the to-be-burned firmware to the storage unit 204.

At block S42, the to-be-burned firmware is burned to the PCIe Switch 31 of the second electronic device 30.

In this embodiment, after obtaining the to-be-burned firmware, the firmware burning device 200 burns the to-be-burned firmware to the PCIe Switch 31 of the second electronic device 30. For example, after the firmware burning device 200 obtains the to-be-burned firmware, the firmware burning device 200 runs the refresh script to burn the to-be-burned firmware to the PCIe Switch 31 of the second electronic device 30. That is, the firmware burning device 200 writes a relevant code of the to-be-burned firmware to a memory for storing the firmware of the PCIe Switch 31. The memory can be the EEPROM or the Flash Memory. Exemplarily, when the firmware burning device 200 is connected to the debug port of the PCIe Switch 31 through the UART port, the firmware burning device 200 transmits the to-be-burned firmware to the debug port of the PCIe Switch 31 through the UART port, and the PCIe Switch 31 writes the relevant code of the to-be-burned firmware received by the debug port to the EEPROM.

In some embodiments, the firmware burning device 200 runs the refresh script to execute a first control command. The first control command is used to indicate burning the to-be-burned firmware to the PCIe Switch 31. Then, the firmware burning device 200 invokes the software tool provided by the vendor of the PCIe Switch 31 according to the first control command to burn the to-be-burned firmware to the PCIe Switch 31.

At block S43, the first firmware information from the PCIe Switch 31 is obtained.

In block S43, after the firmware burning device 200 running the refresh script to burn the to-be-burned firmware to the PCIe Switch 31, the PCIe Switch 31 is restarted and the firmware burning device 200 obtains the first firmware information from the PCIe Switch 31.

In block S43, after the firmware burning device 200 restarting the PCIe Switch 31, the firmware burning device 200 runs the first test script to obtain the first firmware information and detects whether the to-be-burned firmware is successfully burned to the PCIe Switch 31 based on the first firmware information.

In this embodiment, the firmware burning device 200 runs the first test script to executes a second control command. The second control command is used to indicate to obtain the first firmware information sent by the PCIe Switch 31. The firmware burning device 200 invokes the software tool provided by the vendor of the PCIe Switch 31 stored in the firmware burning device 200 according to the second control command, and obtains the first firmware information of the current firmware from the PCIe Switch 31 by using the software tool provided by the vendor of the PCIe Switch 31.

At block S44, whether the to-be-burned firmware being successfully burned to the PCIe Switch 31 is determined based on the predetermined firmware information and the first firmware information.

In block S44, the firmware burning device 200 also runs the first test script to execute a third control command. The third control command is used to indicate to determine whether the to-be-burned firmware is successfully burned to the PCIe Switch 31 based on the predetermined firmware information and the first firmware information.

In block S44, when the firmware burning device 200 detects that the predetermined firmware information is consistent with the first firmware information, the firmware burning device 200 determines that the to-be-burned firmware is successfully burned to the PCIe Switch 31, and block S46 to block S48 are executed. When the firmware burning device 200 detects that the predetermined firmware information is inconsistent with the first firmware information, the firmware burning device 200 determines that the to-be-burned firmware is burned failed, and block S45 is executed.

In this embodiment, when the first firmware information includes the first firmware version number of the current firmware of the PCIe Switch 31, the firmware burning device 200 determines whether the first firmware version number is consistent with the second firmware version number of the to-be-burned firmware. If the version numbers are consistent, the firmware burning device 200 determines that the to-be-burned firmware is successfully burned to the PCIe Switch 31. Conversely, the firmware burning device 200 determines that the to-be-burned firmware is burned failed.

In some embodiments, when the first firmware information also includes the first timestamp, the firmware burning device 200 further determines whether the second timestamp is consistent with the first timestamp. If the timestamps and the version numbers are both consistent, the firmware burning device 200 determines that the to-be-burned firmware is successfully burned to the PCIe Switch 31.

In this embodiment, the timestamps are consistent including the timestamps are close together. For example, a time difference between a first timestamp and a second timestamp is less than a preset threshold, such as 30 seconds, one minute, and so on.

In this embodiment, the predetermined firmware information is consistent with the first firmware information including the first firmware version number is consistent with the second firmware version number, or the first timestamp is consistent with the second timestamp, or the first firmware version number is consistent with the second firmware version number and the first timestamp is consistent with the second timestamp.

In this embodiment, the predetermined firmware information is inconsistent with the first firmware information including the first firmware version number is inconsistent with the second firmware version number, or the first timestamp is inconsistent with the second timestamp, or the first firmware version number is consistent with the second firmware version number but the first timestamp is inconsistent with the second timestamp, or the first firmware version number is inconsistent with the second firmware version number and the first timestamp is inconsistent with the second timestamp, or the first firmware version number is inconsistent with the second firmware version number but the first timestamp is consistent with the second timestamp.

At block S45, the information of burning failure is sent to the first electronic device 10.

In this embodiment, the firmware burning device 200 can send the information of burning failure to the first electronic device 10 through the first communication unit 201.

In block S45, the firmware burning device 200 may also delete the firmware burned failed and re-burn the to-be-burned firmware to the PCIe Switch 31.

At block S46, the first operation information of the PCIe Switch 31 is obtained.

In block S46, if the firmware burning device 200 determines that the to-be-burned firmware A has been successfully burned to the PCIe Switch 31, the first operation information is the running information of the PCIe Switch 31 supported by the firmware A. For example, the first operation information includes, but not limited to, log records of the PCIe Switch 31 supported by the firmware A and register data of the PCIe Switch 31 supported by the firmware A.

In this embodiment, after the firmware burning device 200 determining that the to-be-burned firmware is successfully burned to the PCIe Switch 31, the firmware burning device 200 runs the second test script to obtain the first operation information of the PCIe Switch 31. In some embodiments, after the firmware burning device 200 determining that the to-be-burned firmware has been successfully burned to the PCIe Switch 31, the firmware burning device 200 may also send the information of successful burning to the first electronic device 10.

In this embodiment, the firmware burning device 200 runs the second test script to execute a fourth control command. The fourth control command is used to indicate to obtain the first operational information from the PCIe Switch 31. The firmware burning device 200 invokes the software tool provided by the vendor of the PCIe Switch 31 according to the fourth control command to obtain the first operation information of the PCIe Switch 31.

At block S47, whether the firmware supports the normal operation of the PCIe Switch 31 is determined based on the first operation information.

In this embodiment, the firmware burning device 200 runs the second test script to execute a fifth control command. The fifth control command is used to indicate whether the firmware successfully burned supports the normal operation of the PCIe Switch 31 based on the first operation information.

In block S47, when the firmware burning device 200 determines the firmware successfully burned does not support the normal operation of the PCIe Switch 31, block S48 is executed. When the firmware burning device 200 determines the firmware successfully burned supports the normal operation of the PCIe Switch 31, block S49 is executed.

In block S47, the firmware burning device 200 may compare the first operation information based on a historical storage of run information of the normal operation of the PCIe Switch 31 to determine whether the PCIe Switch 31 operates normally.

At block S48, the information of an abnormal operation of the PCIe Switch 31 is sent to the first electronic device 10.

In block S48, the firmware burning device 200 may also remove the firmware successfully burned and re-burn the to-be-burned firmware to the PCIe Switch 31.

At block S49, the information of a normal operation of the PCIe Switch 31 is sent to the first electronic device 10.

In this embodiment, when the firmware burning device 200 determines that the firmware has been successfully burned to the PCIe Switch 31, the firmware burning device 200 sends the information of a normal operation of the PCIe Switch 31 to the first electronic device 10.

In some embodiments, when the firmware supports a normal operation of the PCIe Switch 31, the firmware burning device 200 store the operational information of the PCIe Switch and sent the operational information to the first electronic device 10.

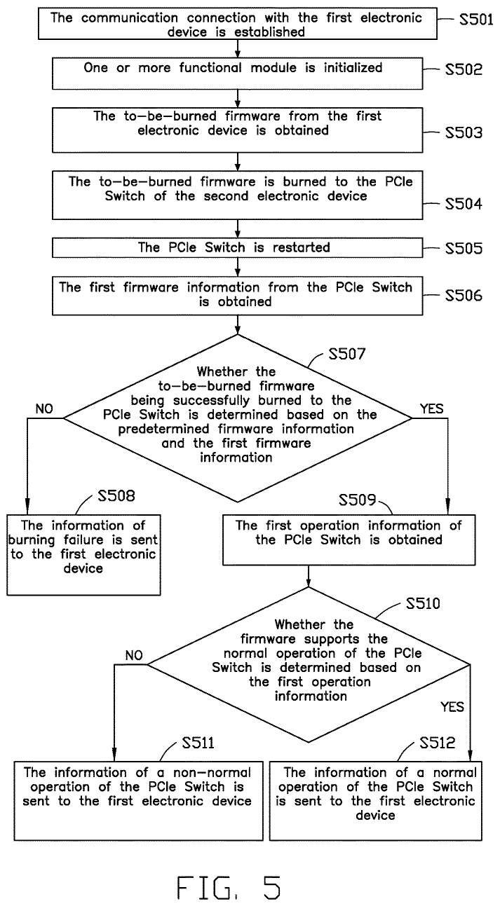

FIG. 5 illustrates another method for automatically burning firmware. As shown in FIG. 5, the method includes blocks S501 to S512. In detail, blocks S503 to S504 of FIG. 5 are the same as the blocks S41 to S42 of FIG. 4 and blocks S506 to S512 of FIG. 5 are the same as the blocks S43 to S48 of FIG. 4. Then, in this embodiment, only blocks S501 to S502 and block S505 will be described and other blocks (that is, blocks S503 to S504 and blocks S506 to S512) will not be repeated herein. Similarly, for a convenience of description, taking the method being performed by the firmware burning device 200 as examples.

At block S501, the communication connection with the first electronic device 10 is established.

In this embodiment, the firmware burning device 200 may receive the first instruction from the first electronic device 10 and establish the communication connection with the first electronic device 10 according to the first instruction. Alternatively, the first electronic device 10 establishes the communication connection with the firmware burning device 200 according to the first instruction.

At block S502, one or more functional module is initialized and block S503 is performed.

In this embodiment, a time for performing block S502 is not limited. For example, block S502 can be performed before or after block S501 or can be performed with block S501.

In block S502, the one or more functional module includes, but is not limited to, the first communication unit, the second communication unit, and the storage unit. Then, the firmware burning device 200 can initialize, for example, the wireless communication module, the UART port, and the Linux tools in the storage unit.

At block S505, the PCIe Switch 31 is restarted.

In block S505, after the firmware burning device 200 burning the to-be-burned firmware to the PCIe Switch 31, the firmware burning device 200 restarts the PCIe Switch 31. For example, the firmware burning device 200 outputs a restart command to the PCIe Switch 31 to control the PCIe Switch 31 to restart.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A firmware burning device comprising:
a first communication unit configured to establish a communication connection with a first electronic device and receive a to-be-burned firmware from the first electronic device;
a second communication unit configured to establish a wired communication with a PCIe Switch; and
a processing unit connected to the first communication unit and the second communication unit,
wherein the processing unit is configured to obtain the to-be-burned firmware received by the first communication unit and burn the to-be-burned firmware to the PCIe Switch through the second communication unit.

2. The device of claim 1, wherein after the PCIe Switch is restarted, the processing unit is further configured to:
obtain a first firmware information of the PCIe Switch through the second communication unit; and
determine whether the to-be-burned firmware is successfully burned to the PCIe Switch based on a predetermined firmware information and the first firmware information.

3. The device of claim 2, wherein determine whether the to-be-burned firmware is successfully burned to the PCIe Switch based on a predetermined firmware information and the first firmware information, further comprises:
determine the to-be-burned firmware is successfully burned to the PCIe Switch, when the predetermined firmware information is consistent with the first firmware information;
determine the to-be-burned firmware is not successfully burned to the PCIe Switch, when the predetermined firmware information is inconsistent with the first firmware information.

4. The device of claim 2, the processing unit is further configured to:
send a first information to the first electronic device through the first communication unit, wherein the first information is configured to indicate that the to-be-burned firmware is successfully burned to the PCIe Switch; and
send a second information to the first electronic device through the first communication unit, wherein the second information is configured to indicate that the to-be-burned firmware is not successfully burned to the PCIe Switch.

5. The device of claim 3, wherein the first firmware information comprises a first firmware version number of a current firmware of the PCIe Switch and a first timestamp at the time of burning the current firmware, and
the predetermined firmware information comprises a second firmware version number of the to-be-burned firmware and a second timestamp at the time of burning the to-be-burned firmware to the PCIe Switch.

6. The device of claim 5, wherein the predetermined firmware information is consistent with the first firmware information, comprises one of the first firmware version number being consistent with the second firmware version number, the first timestamp is consistent with the second timestamp, the first firmware version number is consistent with the second firmware version number, and the first timestamp is consistent with the second timestamp;
the predetermined firmware information is inconsistent with the first firmware information comprises one of the first firmware version number is inconsistent with the second firmware version number, the first timestamp is inconsistent with the second timestamp, the first firmware version number is consistent with the second firmware version number but the first timestamp is inconsistent with the second timestamp, the first firmware version number is inconsistent with the second firmware version number and the first timestamp is inconsistent with the second timestamp, the first firmware version number is inconsistent with the second firmware version number but the first timestamp is consistent with the second timestamp.

7. The device of claim 2, wherein when the to-be-burned firmware is successfully burned to the PCIe Switch, the processing unit is further configured to:
obtain a first operational information of the PCIe Switch; and
determine whether the firmware supports a normal operation of the PCIe Switch according to the first operation information.

8. The device of claim 7, wherein the first operational information comprises a log record and register data of the PCIe Switch.

9. The device of claim 7, wherein the processing unit is further configured to:
send a third information to the first electronic device through the first communication unit, wherein the first information is configured to indicate that the firmware supports the normal operation of the PCIe Switch; and
sent a fourth information to the first electronic device through the first communication unit, wherein the fourth information is configured to indicate that the firmware does not support the normal operation of the PCIe Switch.

10. The device of claim 7, wherein when the firmware supports the normal operation of the PCIe Switch, the processing unit is further configured to:
store an operational information during an operation of the PCIe Switch; and
send the operational information to the first electronic device through the first communication unit.

11. A method for automatically burning firmware applicable in a firmware burning device, the method comprising:
establishing a wireless communication connection with a first electronic device;
receiving a to-be-burned firmware from the first electronic device based on the wireless communication connection established with the first electronic device; and
burning the to-be-burned firmware to a PCIe Switch based on a wired communication connection established with the PCIe Switch.

12. The method of claim 11, wherein after restarting the PCIe Switch, the method further comprises:
obtaining a first firmware information of the PCIe Switch; and
determining whether the to-be-burned firmware is successfully burned to the PCIe Switch based on a predetermined firmware information and the first firmware information.

13. The method of claim 12, wherein steps of determining whether the to-be-burned firmware is successfully burned to the PCIe Switch based on a predetermined firmware information and the first firmware information, the steps comprise:
determining the to-be-burned firmware is successfully burned to the PCIe Switch, when the predetermined firmware information is consistent with the first firmware information; and
determining the to-be-burned firmware is not successfully burned to the PCIe Switch, when the predetermined firmware information is inconsistent with the first firmware information.

14. The method of claim 12, the method further comprises:
sending a first information to the first electronic device, wherein the first information is configured to indicate that the to-be-burned firmware is successfully burned to the PCIe Switch; and
sending a second information to the first electronic device, wherein the second information is configured to indicate that the to-be-burned firmware is not successfully burned to the PCIe Switch.

15. The method of claim 13,
wherein the first firmware information comprises a first firmware version number of a current firmware of the PCIe Switch and a first timestamp at the time of burning the current firmware, and
the predetermined firmware information comprises a second firmware version number of the to-be-burned firmware and a second timestamp at the time of burning the to-be-burned firmware to the PCIe Switch.

16. The method of claim 15,
wherein the predetermined firmware information is consistent with the first firmware information, further comprises one of the first firmware version number being consistent with the second firmware version number, the first timestamp being consistent with the second timestamp, the first firmware version number being consistent with the second firmware version number and the first timestamp being consistent with the second timestamp, and
the predetermined firmware information is inconsistent with the first firmware information comprises one of the first firmware version number being inconsistent with the second firmware version number, the first timestamp being inconsistent with the second timestamp, the first firmware version number being consistent with the second firmware version number but the first timestamp being inconsistent with the second timestamp, the first firmware version number being inconsistent with the second firmware version number and the first timestamp being inconsistent with the second timestamp, the first firmware version number being inconsistent with the second firmware version number but the first timestamp being consistent with the second timestamp.

17. The method of claim 12, wherein when the to-be-burned firmware is successfully burned to the PCIe Switch, the method further comprises:
obtaining a first operational information of the PCIe Switch; and
determining whether the firmware supports a normal operation of the PCIe Switch according to the first operation information.

18. The method of claim 17, wherein the first operational information comprises a log record and register data of the PCIe Switch.

19. The method of claim 17, the method further comprises:
sending a third information to the first electronic device, wherein the third information is configured to indicate that the firmware supports the normal operation of the PCIe Switch; and
sending a fourth information to the first electronic device through the first communication unit, wherein the fourth information is configured to indicate that the firmware does not support the normal operation of the PCIe Switch.

20. The method of claim 17, wherein when the firmware supports the normal operation of the PCIe Switch, the method further comprises:
storing an operational information during an operation of the PCIe Switch; and
sending the operational information to the first electronic device through the first communication unit.
